(19) United States
(12) Patent Application Publication
(10) Pub. No.: US 2026/0058841 A1
(43) Pub. Date: Feb. 26, 2026

(54) RELAY DEVICE, SLEEP CONTROL METHOD, AND SLEEP CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(72) Inventors: Tomohiro OTSU, Yokkaichi-shi, Mie (JP); Hirofumi URAYAMA, Yokkaichi-shi, Mie (JP); Darmawan GO, Yokkaichi-shi, Mie (JP); Kentaro ASHIBE, Yokkaichi-shi, Mie (JP); Takehiro KAWAUCHI, Osaka-shi, Osaka (JP); Shu ISHIZUKA, Toyota-shi, Aichi (JP); Yoshinobu KUROYA, Toyota-shi, Aichi (JP); Kazuya SUGIYAMA, Toyota-shi, Aichi (JP); Yuichiroh ITATSU, Toyota-shi, Aichi (JP); Daigo ISHII, Toyota-shi, Aichi (JP); Hiroya ANDOU, Toyota-shi, Aichi (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP); TOYOTA JIDOSHA KABUSHIKI KAISHA, Toyota-Shi, Aichi (JP)

(21) Appl. No.: 19/099,507

(22) PCT Filed: Jul. 18, 2023
(86) PCT No.: PCT/JP2023/026255

§ 371 Date: Jan. 29, 2025

(30) Foreign Application Priority Data
Aug. 5, 2022 (JP) 2022-125479

(51) Int. Cl. H04L 12/40; B60R 16/023

(52) U.S. Cl. CPC H04L 12/40039; B60R 16/023; H04L 2012/40273

(57) ABSTRACT

A relay device to be used in an in-vehicle system that includes three or more in-vehicle devices, the relay device includes: a state transition unit configured to cause the relay device in a sleep state to transition to a wake-up state when receiving a first wake-up request from a first in-vehicle device of the three or more in-vehicle devices; and a sleep control unit configured to select a second in-vehicle device from among the in-vehicle devices other than the first in-vehicle device and transmit a second wake-up request to the second in-vehicle device to cause the second in-vehicle device to transition to the wake-up state.

### CROSS-REFERENCE TO RELATED APPLICATIONS

This application is the U.S. national stage of PCT/JP2023/026255 filed on Jul. 18, 2023, which claims priority of Japanese Patent Application No. JP 2022-125479 filed on Aug. 5, 2022, the contents of which are incorporated herein.

### TECHNICAL FIELD

The present disclosure relates to a relay device, a sleep control method, and a sleep control program.

### BACKGROUND

JP 2021-160472A discloses the following technique: an in-vehicle device including: a communication unit configured to communicate with an in-vehicle device in an in-vehicle network; a detection unit configured to detect a new in-vehicle device that is an in-vehicle device newly added to the in-vehicle network; and a sleep processing unit configured to, in a detection state where the new in-vehicle device has been detected by the detection unit, transmit a sleep request for transitioning to a sleep state in synchronization with the in-vehicle device in the in-vehicle network to the new in-vehicle device via the communication unit.

There is a demand for a technique that can improve power saving functions beyond the technique described in JP 2021-160472A.

The present disclosure has been made to solve the above-described problem, and aims to provide a relay device, a sleep control method, and a sleep control program that can improve power saving functions in an in-vehicle system.

### SUMMARY

A relay device according to the present disclosure is a relay device to be used in an in-vehicle system that includes three or more in-vehicle devices, the relay device including: a state transition unit configured to cause the relay device in a sleep state to transition to a wake-up state when receiving a first wake-up request from a first in-vehicle device of the three or more in-vehicle devices; and a sleep control unit configured to select a second in-vehicle device from among the in-vehicle devices other than the first in-vehicle device and transmit a second wake-up request to the second in-vehicle device to cause the second in-vehicle device to transition to the wake-up state.

One aspect of the present disclosure can be realized not only as a relay device that includes such characteristic processing units, but also as a semiconductor integrated circuit that realizes a part or the entirety of the relay device, or a system that includes the relay device.

### Effects

With the present disclosure, it is possible to improve the power saving function of the in-vehicle system.

### BRIEF DESCRIPTION OF THE DRAWINGS

FIG. 1 is a diagram showing an example of the configuration of an in-vehicle system according to an embodiment of the present disclosure.

FIG. 2 is a diagram showing an example of the configuration of the relay device according to the embodiment of the present disclosure.

FIG. 3 is a diagram showing an example of a frame transmitted in the in-vehicle system according to the embodiment of the present disclosure.

FIG. 4 is a diagram showing an example of the address table held by the relay device according to the embodiment of the present disclosure.

FIG. 5 is a diagram showing an example of a sequence of sleep processing in the in-vehicle system according to the embodiment of the present disclosure.

FIG. 6 is a diagram showing an example of a sequence of sleep control in an in-vehicle system according to a comparative example.

FIG. 7 is a diagram showing an example of a network table held by the relay device according to the embodiment of the present disclosure.

FIG. 8 is a diagram showing an example of a sequence of sleep control in the in-vehicle system according to the embodiment of the present disclosure.

FIG. 9 is a diagram showing the configuration of Modification 1 of the in-vehicle system according to the embodiment of the present disclosure.

FIG. 10 is a diagram showing a network table held by the relay device in Modification 1 of the in-vehicle system according to the embodiment of the present disclosure.

FIG. 11 is a diagram showing the configuration of Modification 2 of the in-vehicle system according to the embodiment of the present disclosure.

FIG. 12 is a diagram showing a network table held by the relay device in Modification 2 of the in-vehicle system according to the embodiment of the present disclosure.

FIG. 13 is a diagram showing the configuration of Modification 3 of the in-vehicle system according to the embodiment of the present disclosure.

FIG. 14 is a diagram showing a network table held by the relay device in Modification 3 of the in-vehicle system according to the embodiment of the present disclosure.

### DETAILED DESCRIPTION OF PREFERRED EMBODIMENTS

Techniques have been developed to reduce power consumption by performing sleep control to put an in-vehicle device in an in-vehicle system into a sleep mode.

First, the details of an embodiment of the present disclosure are listed and described.

In a first aspect, a relay device according to an embodiment of the present disclosure is a relay device to be used in an in-vehicle system that includes three or more in-vehicle devices, the relay device including: a state transition unit configured to cause the relay device in a sleep state to transition to a wake-up state when receiving a first wake-up request from a first in-vehicle device of the three or more in-vehicle devices; and a sleep control unit configured to select a second in-vehicle device from among the in-vehicle devices other than the first in-vehicle device and transmit a second wake-up request to the second in-vehicle device to cause the second in-vehicle device to transition to the wake-up state.

In this way, with the configuration for selecting, when receiving a wake-up request from a first in-vehicle device, a second in-vehicle device that is the transmission destination of the wake-up request and causing the second in-vehicle device in a sleep state to transition the second in-vehicle device to a wake-up state, it is possible to keep the other in-vehicle devices that are not the communication partner of the first in-vehicle device in sleep state, thereby suppressing the power consumption of the other in-vehicle devices. Therefore, it is possible to improve the power saving function of the in-vehicle system.

In a second aspect, in accordance with the first aspect, a configuration is possible in which, the relay device further including: three or more communication ports to which the three or more in-vehicle devices are to be connected, respectively; and a storage unit configured to store correspondence information indicating a correspondence between the communication ports and networks to which the in-vehicle devices belong, wherein the sleep control unit selects the second in-vehicle device based on the correspondence information.

With such a configuration, it is possible to easily select the second in-vehicle device from among the in-vehicle devices other than the first in-vehicle device.

In a third aspect, in accordance with the second aspect, a configuration is possible in which, the correspondence information indicates a correspondence between the communication ports and VLANs (Virtual Local Area Networks), and the sleep control unit selects, as the second in-vehicle device, an in-vehicle device belonging to the same VLAN as the VLAN corresponding to the communication port to which the first in-vehicle device is connected, based on the correspondence information.

With such a configuration, it is possible to easily select, as the second in-vehicle device, the in-vehicle device belonging to the same network as the network to which the first in-vehicle device belongs.

In a fourth aspect, in accordance with the second aspect, a configuration is possible in which, the correspondence information indicates a correspondence between the communication ports and PNCs (Partial Network Clusters), and the sleep control unit selects, as the second in-vehicle device, an in-vehicle device belonging to the same PNC as the PNC corresponding to the communication port to which the first in-vehicle device is connected, based on the correspondence information.

With such a configuration, it is possible to easily select, as the second in-vehicle device, the in vehicle device belonging to the same network as the network to which the first in-vehicle device belongs.

In a fifth aspect, in accordance with the second aspect, a configuration is possible in which, the correspondence information indicates a correspondence between the communication ports, the VLANs, and the PNCs, and the sleep control unit preferentially selects, as the second in-vehicle device, an in-vehicle device belonging to the same PNC as the PNC corresponding to the communication port to which the first in-vehicle device is connected, over an in-vehicle device belonging to the same VLAN as the VLAN corresponding to the communication port to which the first in-vehicle device is connected.

With such a configuration, when the first in-vehicle device belongs to a plurality of kinds of networks, it is possible to select, as the second in-vehicle device, the in-vehicle device belonging to the PNC that is the network with a higher priority.

In a sixth aspect, a sleep control method according to an embodiment of the present disclosure is a sleep control method for a relay device to be used in an in-vehicle system that includes three or more in-vehicle devices, the sleep control method including the steps of: causing the relay device in a sleep state to transition to a wake-up state when receiving a first wake-up request from a first in-vehicle device of the three or more in-vehicle devices; and selecting a second in-vehicle device from among the in-vehicle devices other than the first in-vehicle device and transmitting a second wake-up request to the second in-vehicle device to cause the second in-vehicle device to transition to the wake-up state.

In this way, with the configuration for selecting, when receiving a wake-up request from a first in-vehicle device, a second in-vehicle device that is the transmission destination of the wake-up request and causing the second in-vehicle device in a sleep state to transition the second in-vehicle device to a wake-up state, it is possible to keep the other in-vehicle devices that are not the communication partner of the first in-vehicle device in sleep state, thereby suppressing the power consumption of the other in-vehicle devices. Therefore, it is possible to improve the power saving function of the in-vehicle system.

In a seventh aspect, a sleep control program according to an embodiment of the present disclosure is a sleep control program to be used in a relay device to be used in an in-vehicle system that includes three or more in-vehicle devices, the sleep control program enabling a computer to function as: a state transition unit configured to cause the relay device in a sleep state to transition to a wake-up state when receiving a first wake-up request from a first in-vehicle device of the three or more in-vehicle devices; and a sleep control unit configured to select a second in-vehicle device from among the in-vehicle devices other than the first in-vehicle device and transmit a second wake-up request to the second in-vehicle device to cause the second in-vehicle device to transition to the wake-up state.

In this way, with the configuration for selecting, when receiving a wake-up request from a first in-vehicle device, a second in-vehicle device that is the transmission destination of the wake-up request and causing the second in-vehicle device in a sleep state to transition the second in-vehicle device to a wake-up state, it is possible to keep the other in-vehicle devices that are not the communication partner of the first in-vehicle device in sleep state, thereby suppressing the power consumption of the other in-vehicle devices. Therefore, it is possible to improve the power saving function of the in-vehicle system.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### In-Vehicle System

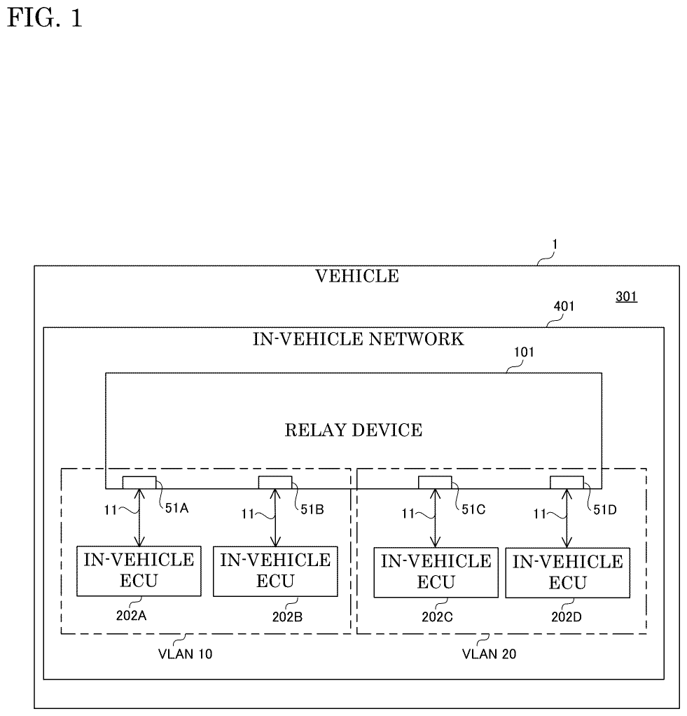

FIG. 1 is a diagram showing an example of the configuration of an in-vehicle system according to an embodiment of the present disclosure.

As shown in FIG. 1, an in-vehicle system 301 includes one or more relay devices 101 and three or more in-vehicle ECUs 202, for example.

In the example shown in FIG. 1, the in-vehicle system 301 includes one relay device 101 and four in-vehicle ECUs 202A, 202B, 202C, and 202D. The relay device 101 and the in-vehicle ECUs 202 form an in-vehicle network 401. The in-vehicle system 301 is installed in a vehicle 1. The in-vehicle ECUs 202 are examples of in-vehicle devices.

Note that the in-vehicle system 301 is not limited to having a configuration that includes one relay device 101, but may have a configuration that includes a plurality of relay devices 101. In addition, the in-vehicle system 301 is not limited to having a configuration that includes four in-vehicle ECUs 202, but may have a configuration that includes three in-vehicle ECUs 202 or five or more in-vehicle ECUs 202.

Examples of the in-vehicle ECUs 202 include a TCU (Telematics Communication Unit), an autonomous driving ECU, a facial recognition ECU, a door lock ECU, a sensor, a navigation device, a human machine interface, a camera, and so on.

In the in-vehicle network 401, for example, the in-vehicle ECUs 202A and 202B and the in-vehicle ECUs 202C and 202D belong to different VLANs.

The ID of the VLAN to which the in-vehicle ECUs 202A and 202B belong is “10”, and the ID of the VLAN to which the in-vehicle ECUs 202C and 202D belong is “20”. In the following description, the ID of a VLAN may be referred to as a “VLAN-ID”.

The relay device 101 and the in-vehicle ECUs 202 are devices that comply with a predetermined in-vehicle network management method. More specifically, the relay device 101 and the in-vehicle ECUs 202 are devices conforming to AUTOSAR (AUTomotive Open System ARchitecture) (registered trademark), which is an example of the in-vehicle network management method.

In the in-vehicle network 401, the in-vehicle ECUs 202 are connected to the relay device 101 via Ethernet (registered trademark) cables 11, for example. The in-vehicle ECUs 202 are each connected to other in-vehicle ECUs 202 via the Ethernet cables 11 and the relay device 101.

The relay device 101 is, for example, a gateway device. The relay device 101 is capable of performing relay processing according to, for example, layer 2 and layer 3, which is higher than layer 2.

More specifically, the relay device 101 performs processing to relay Ethernet frames (hereinafter also simply referred to as “frames”) exchanged between the in-vehicle ECUs 202 connected via the Ethernet cables 11, for example, according to the Ethernet communication standard.

The relay device 101 and each in-vehicle ECU 202 generate a frame including various information described later, and transmit the frame to other in-vehicle ECUs 202 or the relay device 101.

Note that the in-vehicle system 301 is not limited to having a configuration in which frame relay processing is performed according to the Ethernet communication standard, but may have a configuration in which frame relay is performed according to a communication standard such as CAN (Controller Area Network), CAN FD (CAN with Flexible Data Rate), FlexRay (registered trademark), MOST (Media Oriented System Transport) (registered trademark), LIN (Local Interconnect Network), or the like.

### Relay Device

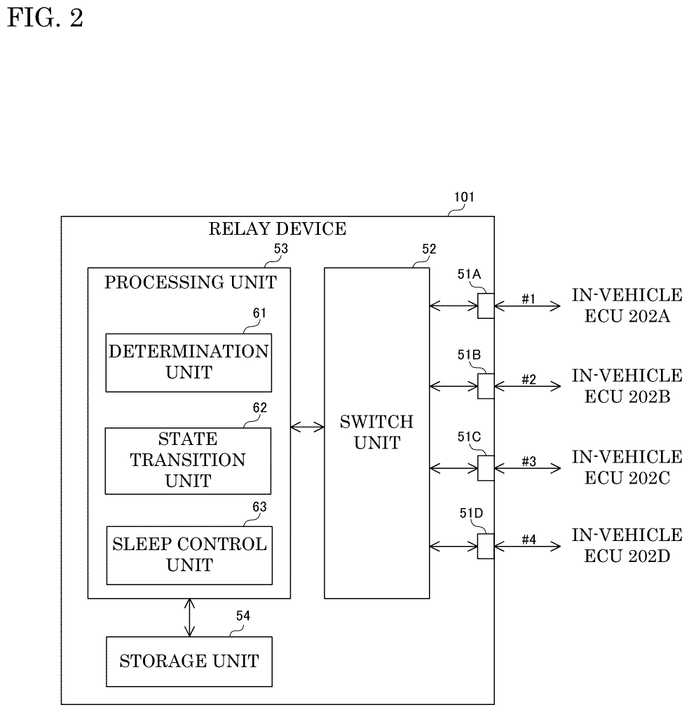

FIG. 2 is a diagram showing an example of the configuration of the relay device according to the embodiment of the present disclosure.

As shown in FIG. 2, the relay device 101 includes communication ports 51, a switch unit 52, a processing unit 53, and a storage unit 54.

Either or both of the switch unit 52 and the processing unit 53 are realized by, for example, processing circuitry including one or more processors. The storage unit 54 is, for example, a non-volatile memory included in the above processing circuitry. The processing unit 53 includes a determination unit 61, a state transition unit 62, and a sleep control unit 63.

More specifically, the relay device 101 includes three or more communication ports 51 to which three or more in-vehicle ECUs 202 are respectively connected. The communication ports 51 are terminals to which the Ethernet cables 11 can be connected, for example.

In the example shown in FIG. 2, the relay device 101 includes four communication ports 51A, 51B, 51C, and 51D, which are the communication ports 51. In the relay device 101, the in-vehicle ECUs 202A, 202B, 202C, and 202D are connected to the communication ports 51A, 51B, 51C, and 51D via the Ethernet cables 11, respectively.

The switch unit 52 includes, for example, a plurality of terminals (not shown) that are connected to the plurality of communication ports 51, respectively. Each terminal is assigned a unique port number.

Here, the port numbers of the terminals connected to the communication ports 51A, 51B, 51C, and 51D are #1, #2, #3, and #4, respectively.

The switch unit 52 relays frames transmitted to and received from the in-vehicle ECUs 202. More specifically, when the switch unit 52 receives a frame from one in-vehicle ECU 202 addressed to another in-vehicle ECU 202 via a communication port 51, the switch unit 52 transmits the received frame to the destination in-vehicle ECU 202.

When the switch unit 52 receives a frame addressed to the relay device 101 from an in-vehicle ECU 202 via a communication port 51, the switch unit 52 outputs

### The Received Frame to the Processing Unit 53.

The switch unit 52 transmits the frame received from the processing unit 53 to the destination in vehicle ECU 202 via a communication port 51.

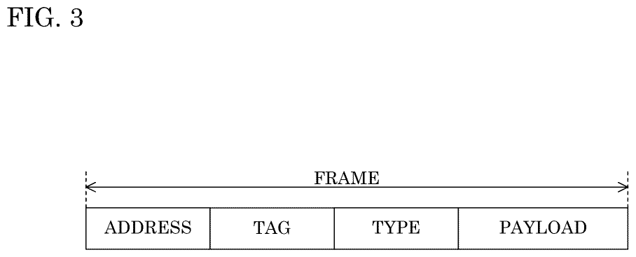

FIG. 3 is a diagram showing an example of a frame transmitted in the in-vehicle system according to the embodiment of the present disclosure.

As shown in FIG. 3, the frame contains address, tag, type, and payload fields.

The address field stores, for example, a destination MAC address and a source MAC address. The tag field stores, for example, a VLAN-ID. The payload stores a destination IP address and various kinds of information.

Here, the MAC addresses of the in-vehicle ECUs 202A, 202B, 202C, and 202D are “MAC-A”, “MAC-B”, “MAC-C”, and “MAC-D”, respectively.

See FIG. 2 again. The storage unit 54 stores a MAC address table (hereinafter also referred to as “address table M”) indicating the correspondence between the MAC addresses of the in-vehicle ECUs 202 and the communication ports 51.

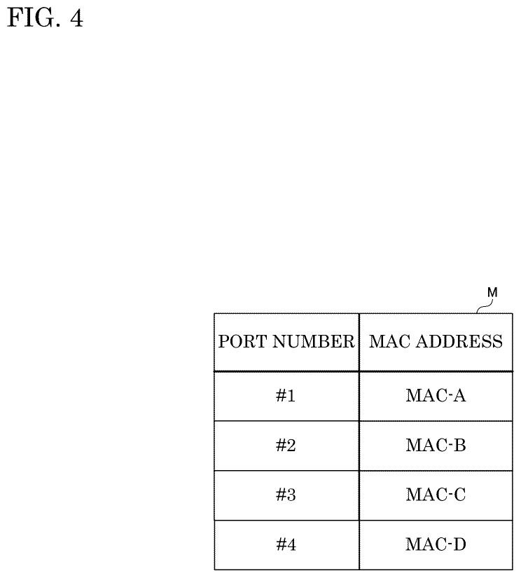

FIG. 4 is a diagram showing an example of the address table held by the relay device according to the embodiment of the present disclosure.

As shown in FIG. 4, in the address table M, the MAC address “MAC-A” is associated with the port number “#1” of the communication port 51A, the MAC address “MAC-B” is associated with the port number “#2” of the communication port 51B, the MAC address “MAC-C” is associated with the port number “#3” of the communication port 51C, and the MAC address “MAC-D” is associated with the port number “#4” of the communication port 51D.

### Sleep State and Wake-up State

The relay device 101 and the in-vehicle ECUs 202 transition from a wake-up state to a sleep state, and also transition from a sleep state to a wake-up state. In the wake-up state, the relay device 101 and the in-vehicle ECUs 202 communicate with other devices in the in-vehicle system 301, and in the sleep state, the relay device 101 and the in-vehicle ECUs 202 stop communicating with other devices in the in-vehicle system 301. Here, the sleep state is a state in which power consumption is reduced compared to the wake-up state, for example, by stopping some of the functions of the device, stopping the power supply to the device, or lowering the clock frequency of the device.

For example, in each of the relay device 101 and the in-vehicle ECUs 202, a sleep condition, which is a condition for transitioning to a sleep state, and a wake-up condition, which is a condition for transitioning to a wake-up state, are set in advance.

For example, the sleep condition is that the ignition of the vehicle 1 is turned off, that the vehicle 1 is parked, or the like. For example, the wake-up condition is that the ignition of the vehicle 1 is turned on, that the vehicle 1 starts moving, or the like.

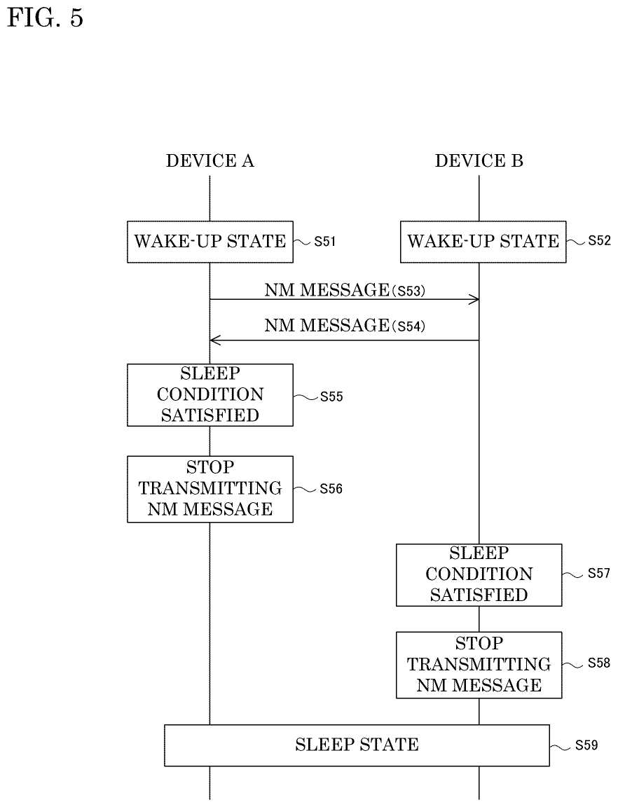

FIG. 5 is a diagram showing an example of a sequence of sleep processing in the in-vehicle system according to the embodiment of the present disclosure. Each of the “device A” and the “device B” shown in FIG. 5 is the relay device 101 or an in-vehicle ECU 202.

As shown in FIG. 5, first, in the wake-up state (steps S51 and S52), each of the devices A and B transmits a frame in which an NM (Network Management) message conforming to AUTOSAR is stored to each device in the in-vehicle system 301. Specifically, for alive monitoring, each of the devices A and B broadcasts a frame in which the NM message is stored in the payload to each device (steps S53 and S54).

Next, when the sleep condition for the device A is satisfied in the wake-up state (step S55), the device A stops transmitting the NM message (step S56).

When the sleep condition for the device B is satisfied in the wake-up state (step S57), the device B stops transmitting the NM message (step S58).

Next, if each of the devices A and B does not receive an NM message from another device in the in-vehicle system 301 within a predetermined time from when the device stopped transmitting the NM message, the devices A and B transition to a sleep state (step S59).

In this way, by switching the states of the devices A and B from a wake-up state to a sleep state using the NM messages, it is possible to reduce the power consumption of the devices A and B.

Note that, in the sleep state (step S59), the devices A and B transition to a wake-up state and start periodically transmitting an NM message when the wake-up condition therefor is satisfied. In addition, in the sleep-state (step S59), the devices A and B transition to a wake-up state when receiving a wake-up request from another device in the in-vehicle system 301.

### Determination Unit

See FIG. 2 again. The determination unit 61 in the relay device 101 determines whether or not the sleep condition for the relay device 101 is satisfied and whether or not the wake-up condition for the relay device 101 is satisfied.

More specifically, the determination unit 61 monitors the state of the vehicle 1, and performs determination processing to determine whether or not the sleep condition for the relay device 101 is satisfied and whether or not the wake-up condition for the relay device 101 is satisfied, based on the result of the monitoring. For example, the determination unit 61 performs determination processing periodically, and notifies the state transition unit 62 of the result of the determination.

### State Transition Unit

The state transition unit 62 causes the relay device 101 to transition to a sleep state. The state transition unit 62 also causes the relay device 101 to transition to a wake-up state.

Here, the switch unit 52 includes a plurality of communication circuits corresponding to the plurality of communication ports 51, respectively. When the relay device 101 is in the sleep state, all of the communication circuits in the switch unit 52 are inactive. When the relay device 101 is in the wake-up state, at least one of the plurality of communication circuits in the switch unit 52 is active. Hereinafter, the state in which a communication circuit in the switch unit 52 is inactive is referred to as an “OFF state”, and the state in which the communication circuit is active is referred to as an “ON state”.

More specifically, when the relay device 101 is in the wake-up state and the state transition unit 62 receives, from the determination unit 61, a notification indicating that the sleep condition has been satisfied, the state transition unit 62 causes the relay device 101 to transition to a sleep state.

When the relay device 101 is in the sleep state and the state transition unit 62 receives, from the determination unit 61, a notification indicating that the wake-up condition has been satisfied, the state transition unit 62 causes the relay device 101 to transition to a wake-up state.

When the state transition unit 62 receives a wake-up request from an in-vehicle ECU 202 via a communication port 51 and the switch unit 52, the state transition unit 62 causes the relay device 101 in the sleep state to transition to a wake-up state. Hereinafter, the wake-up request transmitted from an in-vehicle ECU 202 to the relay device 101 is also referred to as a “wake-up request R1”. The wake-up request R1 is an example of the first wake-up request. Note that the term “first” does not imply a priority order.

More specifically, an in-vehicle ECU 202 transmits a wake-up request R1 to the relay device 101 directly connected thereto via an Ethernet cable 11. For example, the wake-up request R1 is a high-level pulse signal. For example, the in-vehicle ECU 202 transmits the high-level pulse signal to the relay device 101 according to the OPEN Alliance standard.

Upon receiving the wake-up request R1 from the in-vehicle ECU 202 via the communication port 51, the switch unit 52 outputs to the state transition unit 62 and the sleep control unit 63 a reception notification indicating the fact that the wake-up request R1 has been received and the port number of the communication port 51 that has received the wake-up request R1.

Upon receiving the reception notification from the switch unit 52, the state transition unit 62 causes the relay device 101 to transition from a sleep state to a wake-up state. More specifically, the state transition unit 62 causes the communication circuits corresponding to the communication ports 51 that have received the wake-up request R1 to transition from the OFF state to the ON state.

Thereafter, the relay device 101 and the in-vehicle ECU 202 establish a communication connection with each other by exchanging frames including various kinds of information.

### Sleep Control Unit

The sleep control unit 63 performs control to cause the in-vehicle ECUs 202 to transition to a wake-up state.

More specifically, for example, when an in-vehicle ECU 202 is in the sleep state, the sleep control unit 63 transmits a wake-up request, such as a high-level pulse signal, to the in-vehicle ECU 202 to be woken up, via the switch unit 52 and the communication port 51. Upon receiving the wake-up request, the in-vehicle ECU 202 transitions to a wake-up state. Hereinafter, the wake-up request transmitted from the relay device 101 to an in-vehicle ECU 202 is also referred to as a “wake-up request R2”. The wake-up request R2 is an example of the second wake-up request. Note that the term “second”does not imply a priority order.

In the in-vehicle system 301 including the relay device 101 and three or more in-vehicle ECUs 202, the relay device 101 and each of the in-vehicle ECUs 202 may be in a sleep state. In this case, when an in-vehicle ECU 202 transitions to a wake-up state due to the need to communicate with another in-vehicle ECU 202, the in-vehicle ECU 202 transmits a wake-up request R1 to the relay device 101. Here, an example will be described in which the in-vehicle ECU 202A transitions to a wake-up state in order to communicate with the in-vehicle ECU 202B and transmits a wake-up request R1 to the relay device 101.

The relay device 101 receives the wake-up request R1 and transitions to a wake-up state. However, the wake-up request R1 is a high-level pulse signal and does not include information indicating the communication partner of the in-vehicle ECU 202A. Therefore, even if the relay device 101 receives the wake-up request R1, the relay device 101 cannot determine which in-vehicle ECU 202 of the in-vehicle ECUs 202B, 202C, and 202D other than the in-vehicle ECU 202A should be caused to transition to the wake-up state. The details of such a problem will be described below.

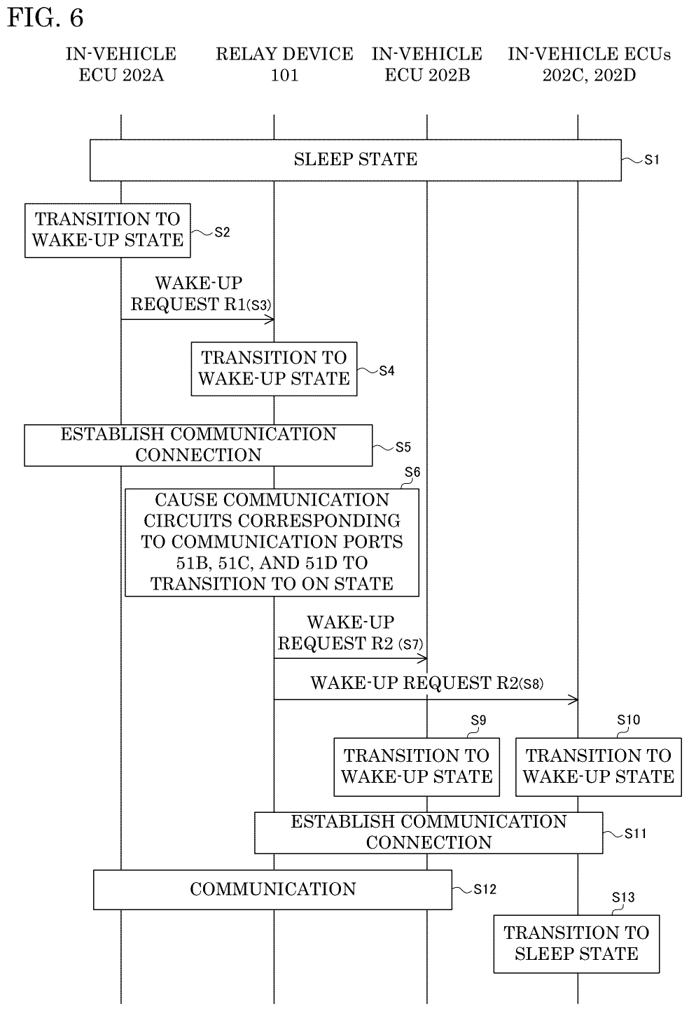

FIG. 6 is a diagram showing an example of a sequence of sleep control in an in-vehicle system according to a comparative example. The in-vehicle system according to the comparative example described below is different from the in-vehicle system according to the embodiment of the present disclosure in that the above-mentioned problem occurs in sleep control. In the comparative example described below, the vehicle, the in-vehicle system, and each device in the in-vehicle system are given the same reference numerals as those in the embodiment of the present disclosure.

Here, an example is assumed in which the in-vehicle system 301 according to the comparative example is a system installed in the vehicle 1 whose door lock can be released through facial recognition, the in-vehicle ECU 202A is an ECU for facial recognition, the in-vehicle ECU 202B is an ECU for door locking, and the relay device 101 and each in-vehicle ECU 202 are in a sleep state while the vehicle 1 is parked.

As shown in FIG. 6, it is assumed that in a situation where the relay device 101 and the in-vehicle ECUs 202A, 202B, 202C, and 202D are in a sleep state (step S1), the in-vehicle ECU 202A first transitions to a wake-up state. Here, it is assumed that the facial recognition has been successful and the in-vehicle ECU 202A has transitioned to a wake-up state due to the need to request the in-vehicle ECU 202B to unlock the doors (step S2).

Next, the in-vehicle ECU 202A transmits a wake-up request R1 to the relay device 101 (step S3).

Next, the relay device 101 receives the wake-up request R1 from the in-vehicle ECU 202A and transitions to a wake-up state. More specifically, the state transition unit 62 in the relay device 101 causes the communication circuit corresponding to the communication port 51A that has received the wake-up request R1 to transition from the OFF state to the ON state (step S4).

Next, the relay device 101 and the in-vehicle ECU 202A establish a communication connection with each other by exchanging various kinds of information (step S5).

Next, the state transition unit 62 in the relay device 101 causes the communication circuits corresponding to the communication ports 51B, 51C, and 51D other than the communication port 51A to transition from the OFF state to the ON state. In this way, in the in-vehicle system 301 in the comparative example, even if the relay device 101 establishes a communication connection with the in-vehicle ECU 202A, it is unable to identify the communication partner of the in-vehicle ECU 202A because the wake-up request R1 does not include information indicating the communication partner of the in-vehicle ECU 202A (step S6).

Next, the relay device 101 transmits a wake-up request R2 to the in-vehicle ECUs 202B, 202C, and 202D (steps S7 and S8).

Next, the in-vehicle ECUs 202B, 202C, and 202D receive the wake-up request R2 from the relay device 101 and transition to a wake-up state (steps S9 and S10).

Next, the relay device 101 and the in-vehicle ECUs 202B, 202C, and 202D establish communication connections with each other by exchanging various kinds of information (step S11).

Next, the in-vehicle ECUs 202A and 202B communicate with each other. For example, upon receiving a frame addressed to the in-vehicle ECU 202B from the in-vehicle ECU 202A, the relay device 101 references the address table M and specifies “#2” as the port number corresponding to the frame. Thereafter, the relay device 101 transmits the received frame from the communication port 51B corresponding to the specified port number “#2” to the destination in-vehicle ECU 202B (step S12).

After transitioning to the wake-up state (S10), the in-vehicle ECUs 202C and C,202D, which are not communication partners of the in-vehicle ECU 202A, stop transmitting NM messages when the sleep conditions therefor are satisfied if they are not to communicate with other in-vehicle ECUs 202. Thereafter, if the in-vehicle ECUs 202C and 202D do not receive an NM message from another device in the in-vehicle system 301 within a predetermined time from when they stopped transmitting the NM messages, they transition to a sleep state (step S13).

In this way, in the in-vehicle system 301 according to the comparative example, when the relay device 101 receives a wake-up request from the in-vehicle ECU 202A, the relay device 101 causes the other in-vehicle ECUs 202B, 202C, and 202D in the sleep state to transition to a wake-up state. Therefore, in the in-vehicle system 301 according to the comparative example, the in-vehicle ECUs 202C and 202D, which are not communication partners of the in-vehicle ECU 202A, transition to a wake-up state, resulting in extra power consumption.

In contrast, the relay device 101 according to the embodiment of the present disclosure solves such a problem by using the following configuration and operation.

### Relay Device

See FIG. 2 again. The storage unit 54 stores a table indicating the correspondence between the communication ports 51 and the networks to which the in-vehicle ECUs 202 belong (hereinafter also referred to as a “network table T”). The network table T is an example of the correspondence information.

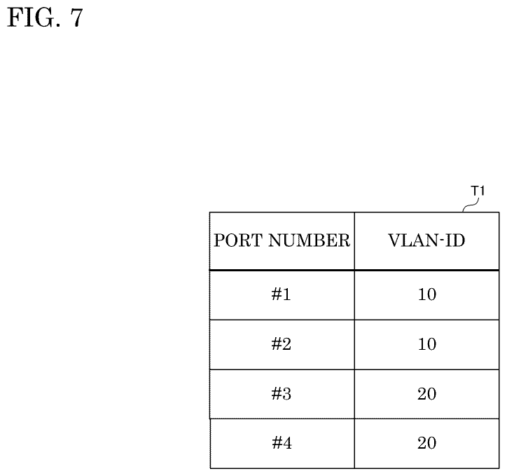

FIG. 7 is a diagram showing an example of a network table held by the relay device according to the embodiment of the present disclosure.

As shown in FIG. 7, a network table TI indicates the correspondence between the communication ports 51 and the VLANs. More specifically, the network table T1 indicates the correspondence between the port numbers of the communication ports 51 and the VLAN-IDs of the in-vehicle ECUs 202.

As described above, in the example shown in FIG. 1, the VLAN-IDs of the in-vehicle ECUs 202A and 202B are “10”, and the VLAN-IDs of the in-vehicle ECUs 202C and 202D are “20”. Therefore, in the network table T1, the VLAN-ID “10” is associated with the port numbers “#1” and “#2”, and the VLAN-ID “20” is associated with the port numbers “#3” and “#4”.

The following describes processing in which, when the in-vehicle ECU 202A transitions to the wake-up state in order to communicate with the in-vehicle ECU 202B, the relay device 101 only causes the in-vehicle ECU 202B to transition to the wake-up state. The in-vehicle ECU 202A is an example of the first in-vehicle device, and the in-vehicle ECU 202B is an example of the second in-vehicle device.

As shown in FIGS. 1, 2, and 7, when the sleep control unit 63 receives a wake-up request R1 from the in-vehicle ECU 202A and the relay device 101 therefor transitions to a wake-up state, the sleep control unit 63 selects the transmission destination of the wake-up request R2 from among the in-vehicle ECUs 202B, 202C, and 202D other than the in-vehicle ECU 202A based on the network table T1.

Here, the sleep control unit 63 selects the in-vehicle ECU 202B belonging to the same VLAN as the VLAN corresponding to the communication port 51A to which the in-vehicle ECU 202A is connected, based on the network table T1.

More specifically, the sleep control unit 63 determines that the communication circuit corresponding to the communication port 51 whose port number is indicated by the reception notification received from the switch unit 52 has transitioned from the OFF state to the ON state. Here, the switch unit 52 notifies the sleep control unit 63 of the port number “#1” of the communication port 51A that has received the wake-up request R1, and the sleep control unit 63 determines that the communication circuit corresponding to the communication port 51A has transitioned to the ON state.

Thereafter, the sleep control unit 63 references the network table T1, specifies “10” as the same VLAN-ID as the VLAN-ID corresponding to the port number “#1” notified by the switch unit 52, and specifies “#2” as another port number corresponding to the VLAN-ID “10”. As a result, the sleep control unit 63 specifies the in-vehicle ECU 202B connected to the communication port 51B with the port number “#2” as the communication partner of the in-vehicle ECU 202A. That is to say, the sleep control unit 63 selects the in-vehicle ECU 202B from among the in-vehicle ECUs 202B, 202C, and 202D as the transmission destination of the wake-up request R2. Thereafter, the sleep control unit 63 causes the communication circuit corresponding to the communication port 51B to transition from the OFF state to the ON state.

The sleep control unit 63 transmits a wake-up request R2 to the in-vehicle ECU 202B to cause the in-vehicle ECU 202B to transition to a wake up state.

More specifically, the sleep control unit 63 transmits a wake-up request R2 to the in-vehicle ECU 202B via the switch unit 52 and the communication port 51B.

The in-vehicle ECU 202B receives the wake-up request R2 from the relay device 101 and transitions to a wake-up state.

When the in-vehicle ECU 202B transitions to the wake-up state, the relay device 101 and the in-vehicle ECU 202B establish a communication connection with each other by exchanging various kinds of information.

After the relay device 101 and the in-vehicle ECU 202B establish a communication connection, the in-vehicle ECU 202A transmits frames addressed to the in-vehicle ECU 202B to the relay device 101 periodically or irregularly.

Upon receiving a frame addressed to the in-vehicle ECU 202B, i.e., a frame including the destination MAC address “MAC-B”, the switch unit 52 in the relay device 101 references the address table M shown in FIG. 4 and specifies “#2” as the port number corresponding to the MAC address “MAC-B”. Thereafter, the relay device 101 transmits the frame addressed to the in-vehicle ECU 202B from the communication port 51B. As a result, the in-vehicle ECU 202A can communicate with the in-vehicle ECU 202B via the relay device 101.

For example, when the connection relationship between the relay device 101 and each of the in-vehicle ECUs 202 in the in-vehicle network 401 is fixed, the relay device 101 holds the network table T1 created in advance in the storage unit 54. Note that the relay device 101 may acquire the VLAN-IDs stored in the tag fields of the frames respectively received from the in-vehicle ECUs 202, and create a network table T1 based on the acquired VLAN-IDs and the port numbers of the communication ports that have received the frames.

In addition, the sleep control unit 63 is not limited to having a configuration for selecting the in-vehicle ECU 202B to be the transmission destination of the wake-up request R2 from among the in-vehicle ECUs 202B, 202C, and 202D other than the in-vehicle ECU 202A, based on the network table T1. The sleep control unit 63 may select a plurality of in-vehicle ECUs 202 included in the in-vehicle ECUs 202B, 202C, and 202D other than the in-vehicle ECU 202A.

### Operation Flow

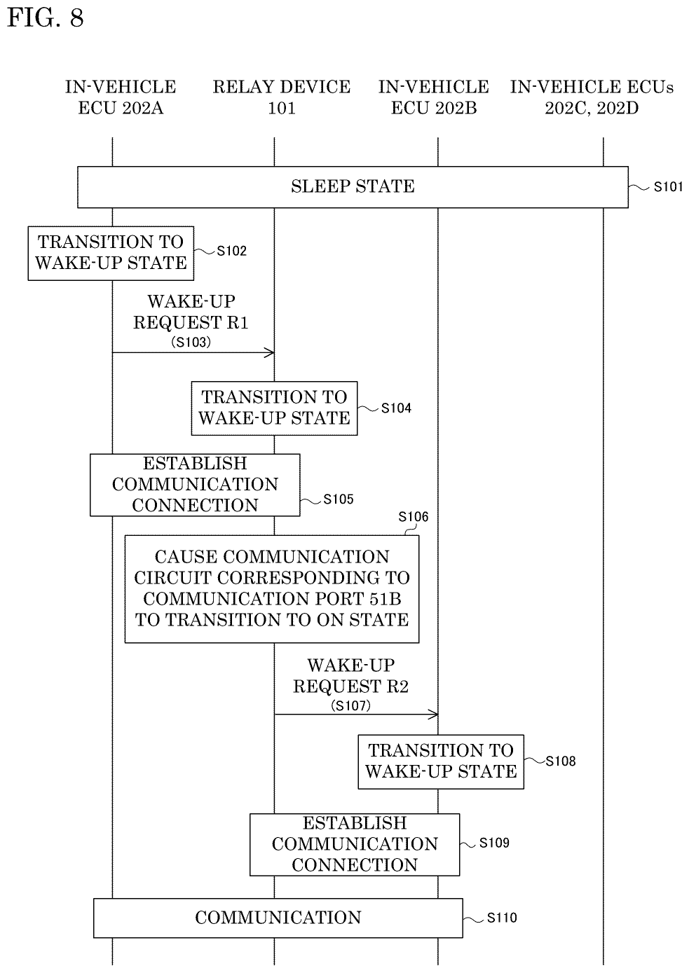

FIG. 8 is a diagram showing an example of a sequence of sleep control in the in-vehicle system according to the embodiment of the present disclosure.

As shown in FIG. 8, first, it is assumed that, when the relay device 101 and the in-vehicle ECUs 202A, 202B, 202C, and 202D are in a sleep state (step S101), the in-vehicle ECU 202A has transitioned to a wake-up state (step S102).

Next, the in-vehicle ECU 202A transmits a wake-up request R1 to the relay device 101 (step S103).

Next, the relay device 101 receives the wake-up request R1 from the in-vehicle ECU 202A and transitions to a wake-up state. More specifically, the state transition unit 62 in the relay device 101 causes the communication circuit corresponding to the communication port 51A that has received the wake-up request R1 to transition from the OFF state to the ON state (step S104).

Next, the relay device 101 and the in-vehicle ECU 202A establish a communication connection with each other by exchanging various kinds of information

Next, the relay device 101 references the network table T1 in the storage unit 54, and selects the in-vehicle ECU 202B from among the in-vehicle ECUs 202B, 202C, and 202D other than the in-vehicle ECU 202A, as the transmission destination of a wake-up request R2. Specifically, the sleep control unit 63 in the in the relay device 101 selects the in-vehicle ECU 202B belonging to the same VLAN as the VLAN corresponding to the communication port 51A to which the in-vehicle ECU 202A is connected, from among the in-vehicle ECUs 202B, 202C, and 202D, based on the network table T1. Thereafter, the sleep control unit 63 causes the communication circuit corresponding to the communication port 51B to which the in-vehicle ECU 202B is connected, to transition to the ON state (step S106).

Next, the relay device 101 transmits a wake-up request R2 to the in-vehicle ECU 202B (step S107).

The in-vehicle ECU 202B receives the wake-up request R2 from the relay device 101 and transitions to a wake-up state (step S108).

Next, the relay device 101 and the in-vehicle ECU 202B establish a communication connection with each other by exchanging various kinds of information (step S109).

Next, the in-vehicle ECUs 202A and 202B communicate with each other. For example, upon receiving a frame addressed to the in-vehicle ECU 202B from the in-vehicle ECU 202A, the relay device 101 references the address table M and specifies “#2” as the port number corresponding to the frame. Thereafter, the relay device 101 transmits the received frame from the communication port 51B corresponding to the specified port number “#2” to the destination in-vehicle ECU 202B (step S110).

Note that, in FIG. 8, when the in-vehicle ECU 202A transitions to the up state, one of the in-vehicle ECUs 202C and 202D may be in a sleep state and the other may be in a wake-up state. Even in this case, the relay device 101 does not cause the in-vehicle ECU 202 in the sleep state of the in-vehicle ECUs 202C and 202D to transition to the wake-up state, so that power consumption of the in-vehicle ECU 202 can be suppressed.

### Modification 1

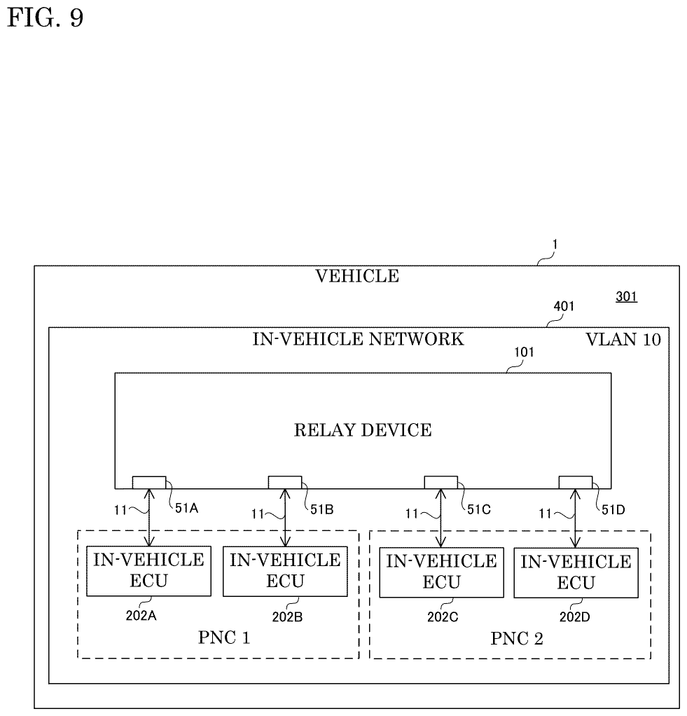

FIG. 9 is a diagram showing the configuration of Modification 1 of the in-vehicle system according to the embodiment of the present disclosure.

As shown in FIG. 9, in Modification 1, the VLAN-IDs of the in-vehicle ECUs 202 are “10”. In this way, in Modification 1, it is assumed that the in-vehicle ECUs 202 have the same VLAN-ID.

In Modification 1, the in-vehicle ECUs 202 form a PN (Partial Network) defined by AUTOSAR. Specifically, the plurality of in-vehicle ECUs 202 form PNCs, which are examples of networks, in accordance with the AUTOSAR standards. In the example shown in FIG. 9, the in-vehicle ECUs 202A and 202B and the in-vehicle ECUs 202C and 202D belong to different PNCs. Each in-vehicle ECU 202 selects a communication partner from among the in-vehicle ECUs 202 belonging to the same PNC.

In the following description, the ID of the PNC to which the in-vehicle ECUs 202A and 202B belong, i.e., their PN information, is “1”, and the PN information regarding the in-vehicle ECUs 202C and 202D is “2”. PN information is stored in an NM message, for example.

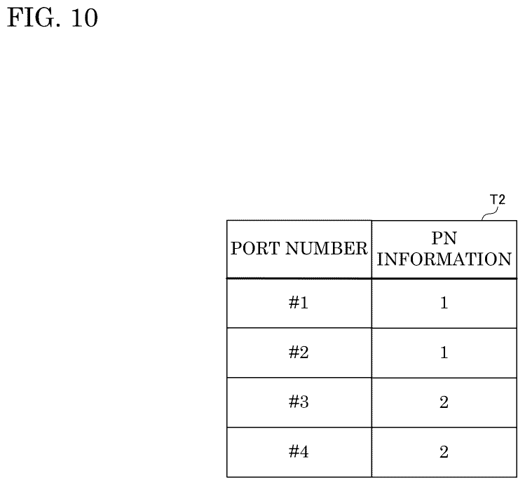

FIG. 10 is a diagram showing a network table held by the relay device in Modification 1 of the in-vehicle system according to the embodiment of the present disclosure.

As shown in FIGS. 2 and 10, the storage unit 54 stores a network table T2 indicating the correspondence between the communication ports 51 and the PNCs. More specifically, the network table T2 indicates the correspondence between the port numbers of the communication ports 51 and the pieces of PN information regarding the in-vehicle ECUs 202.

In the network table T2, the PN information “1” is associated with the port numbers “#1” and “#2”, and the PN information “2” is associated with the port numbers “#3” and “#4”. Note that the network table T2 may indicate the VLAN-ID corresponding to the port numbers, i.e., the VLAN-ID “10”.

The sleep control unit 63 selects, from among the in-vehicle ECUs 202B, 202C, and 202D, the in-vehicle ECU 202B belonging to the same PNC as the PNC corresponding to the communication port 51A to which the in-vehicle ECU 202A is connected, based on the network table T2.

More specifically, the sleep control unit 63 references the network table T2, specifies “1” as the PN information that is the same as the PN information corresponding to the port number “#1” notified by the switch unit 52, and specifies “#2” as another port number corresponding to the PN information “1”. As a result, the sleep control unit 63 specifies the in-vehicle ECU 202B connected to the communication port 51B with the port number “#2” as the communication partner of the in-vehicle ECU 202A. That is to say, the sleep control unit 63 selects the in-vehicle ECU 202B from among the in-vehicle ECUs 202B, 202C, and 202D as the transmission destination of

For example, when the connection relationship between the relay device 101 and each of the in-vehicle ECUs 202 in the in-vehicle network 401 is fixed, the relay device 101 holds the network table T2 created in advance in the storage unit 54. Note that the relay device 101 may acquire pieces of PN information stored in the NM messages received from the in-vehicle ECUs 202, and create a network table T2 based on the acquired pieces of PN information and the port numbers of the communication ports 51 that have received the NM messages.

### Modification 2

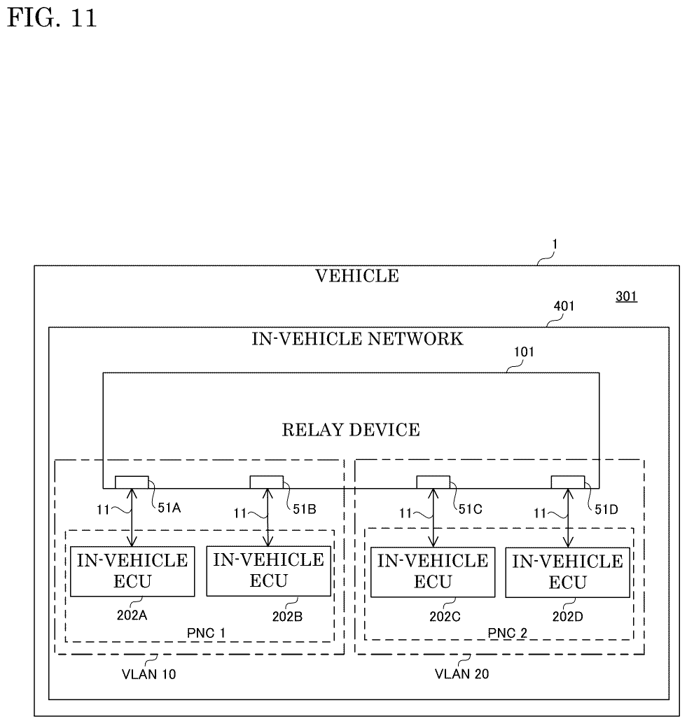

FIG. 11 is a diagram showing the configuration of Modification 2 of the in-vehicle system according to the embodiment of the present disclosure.

As shown in FIG. 11, in Modification 2, as in the in-vehicle system 301 shown in FIG. 1, the in-vehicle ECUs 202A and 202B and the in-vehicle ECUs 202C and 202D belong to different VLANs. In addition, in Modification 2, as in Modification 1, the in-vehicle ECUs 202A and 202B and the in-vehicle ECUs 202C and 202D belong to different PNCs.

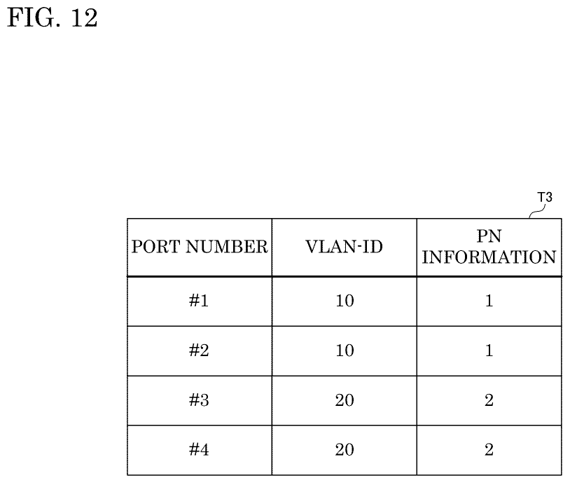

FIG. 12 is a diagram showing a network table held by the relay device in Modification 2 of the in-vehicle system according to the embodiment of the present disclosure.

As shown in FIGS. 2 and 12, the storage unit 54 stores a network table T3 indicating the correspondence between the communication ports 51, the VLANs, and the PNCs. More specifically, the network table T3 indicates the correspondence between the port numbers of the communication ports 51, the VLAN-IDs of the in-vehicle ECUs 202, and the pieces of PN information of the in-vehicle ECUs 202. In the network table T3, the in-vehicle ECUs 202 belonging to the same VLAN have the same PN information.

More specifically, in the network table T3, the set of the VLAN-ID “10” and the PN information “1” is associated with the port numbers “#1” and “#2”, and the set of the VLAN-ID “20” and the PN information “2” is associated with the port numbers “#3” and “#4”.

The sleep control unit 63 preferentially selects the in-vehicle ECU 202 belonging to the same PNC as the PNC corresponding to the communication port 51A, over the in-vehicle ECU 202 belonging to the same VLAN as the VLAN corresponding to the communication port 51A to which the in-vehicle ECU 202A is connected, based on the network table T3.

More specifically, the sleep control unit 63 references the network table T3, specifies “1” as the PN information that is the same as the PN information corresponding to the port number “#1” notified by the switch unit 52, and specifies “#2” as another port number corresponding to the PN information “1”. As a result, the sleep control unit 63 specifies the in-vehicle ECU 202B connected to the communication port 51B with the port number “#2” as the communication partner of the in-vehicle ECU 202A. That is to say, the sleep control unit 63 selects the in-vehicle ECU 202B from among the in-vehicle ECUs 202B, 202C, and 202D as the transmission destination of the wake-up request R2.

### Modification 3

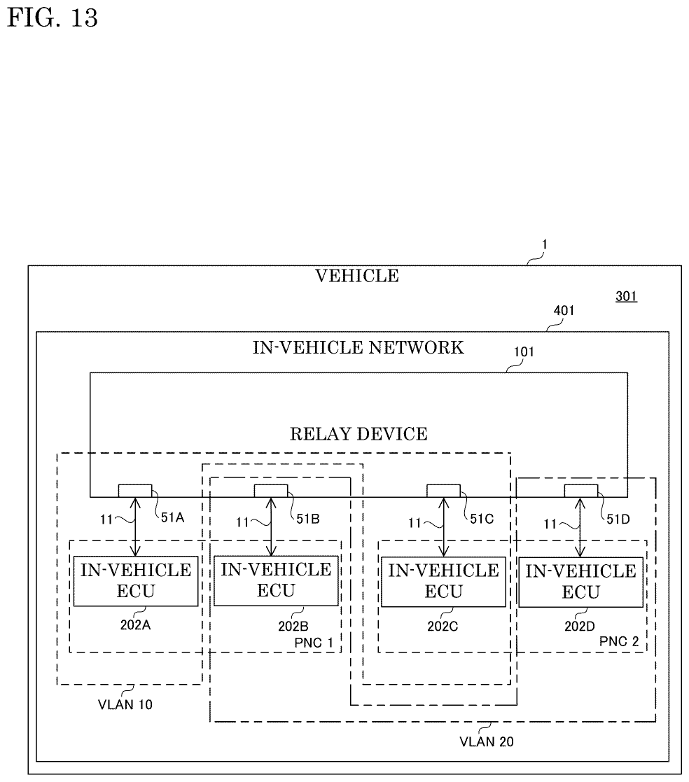

FIG. 13 is a diagram showing the configuration of Modification 3 of the in-vehicle system according to the embodiment of the present disclosure.

As shown in FIG. 13, in Modification 3, the in-vehicle ECUs 202A and 202C and the in-vehicle ECUs 202B and 202D belong to different VLANs. In the example shown in FIG. 13, the VLAN-IDs of the in-vehicle ECUs 202A and 202C are “10” and the VLAN-IDs of the in-vehicle ECUs 202B and 202D are “20”. In addition, in Modification 3 as in Modifications 1 and 2, the in-vehicle ECUs 202A and 202B and the in-vehicle ECUs 202C and 202D belong to different PNCs.

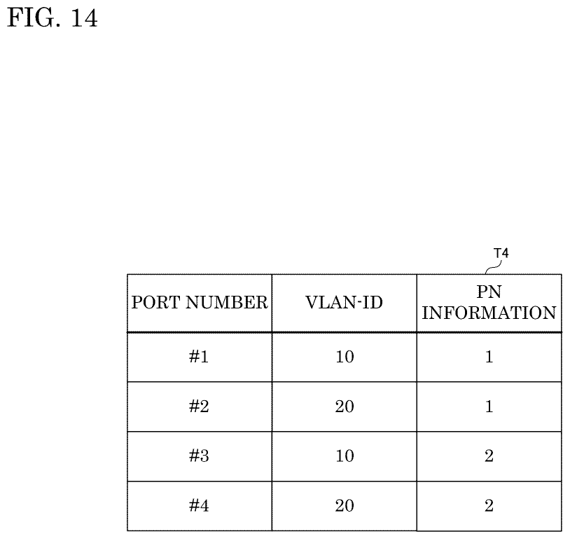

FIG. 14 is a diagram showing a network table held by the relay device in Modification 3 of the in-vehicle system according to the embodiment of the present disclosure.

As shown in FIGS. 2 and 14, the storage unit 54 stores a network table T4 indicating the correspondence between the communication ports 51, the VLANs, and the PNCs. More specifically, the network table T4 indicates the correspondence between the port numbers of the communication ports 51, the VLAN-IDs of the in-vehicle ECUs 202, and the pieces of PN information of the in-vehicle ECUs 202. In the network table T4, the in-vehicle ECUs 202 belonging to the same VLAN have different pieces of PN information.

More specifically, in the network table T4, the set of the VLAN-ID “10” and the PN information “1” is associated with the port number “#1”, the set of the VLAN-ID “20” and the PN information “1” is associated with the port number “#2”, the set of the VLAN-ID “10” and the PN information “2” is associated with the port number “#3”, and the set of the VLAN-ID “20” and the PN information “2” is associated with the port number “#4”.

The sleep control unit 63 preferentially selects the in-vehicle ECU 202B belonging to the same PNC as the PNC corresponding to the communication port 51A, over the in-vehicle ECU 202C belonging to the same VLAN as the VLAN corresponding to the communication port 51A to which the in-vehicle ECU 202A is connected, based on the network table T4.

More specifically, the sleep control unit 63 references the network table T4, specifies “10” as the same VLAN-ID as the VLAN-ID corresponding to the port number “#1” notified by the switch unit 52, and specifies “#3” as another port number corresponding to the VLAN-ID “10”. Also, the sleep control unit 63 references the network table T4, specifies “1” as the PN information that is the same as the PN information corresponding to the port number “#1” notified by the switch unit 52, and specifies “#2” as another port number corresponding to the PN information “1”.

Thereafter, the sleep control unit 63 preferentially selects the in-vehicle ECU 202B connected to the communication port 51B with the port number “#2”, over the in-vehicle ECU 202C connected to the communication port 51C with the port number “#3” as the transmission destination of the wake-up request R2.

Note that the network table T is not limited to the network tables T1, T2, T3, or T4 mentioned above. The network table T may be a table showing the correspondence between the port numbers of the communication ports 51, which are the port numbers of physical ports, and the numbers of logical ports.

For example, when the same logical port is assigned to the communication port 51A to which the in-vehicle ECU 202A is connected and the communication port 51B to which the in-vehicle ECU 202B is connected, and a wake-up request R1 is transmitted from the in-vehicle ECU 202A to the relay device 101, the sleep control unit 63 in the relay device 101 selects the in-vehicle ECU 202B from among the in-vehicle ECUs 202B, 202C, and 202D other than the in-vehicle ECU 202A as the transmission destination of the wake-up request R2.

The foregoing embodiments are to be construed in all respects as illustrative and not restrictive. The scope of the present disclosure is defined by the claims rather than the description above, and is intended to include all modifications within the meaning and scope of the claims and equivalents thereof.

Each type of processing (each function) in the above embodiment is realized by a circuitry including one or more processors. The circuitry may be constituted by an integrated circuit or the like that combines one or more memories, various analog circuits, and various digital circuits, in addition to the one or more processors. The one or more memories store programs (instructions) that cause the one or more processors to execute each type of the above processing. The one or more processors may execute each type of the above processing according to the programs read out from the one or more memories, or may execute each type of the above processing according to a logic circuit designed in advance to execute each type of the above processing. The processors may be various processors suitable for computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that a plurality of physically separated processors may cooperate with each other to execute each type of the above processing. For example, the processors installed in a plurality of physically separate computers may cooperate with each other via a network such as a LAN (Local Area Network), a WAN (Wide Area Network), or the internet to execute each type of the above processing. The above programs may be installed in the memories via the network from an external server device or the like, or may be distributed in a state stored on a recording medium such as a CD-ROM (Compact Disc Read Only Memory), a DVD-ROM (Digital Versatile Disk Read Only Memory), or semiconductor memory, and installed in the memories from the recording medium.

The above description includes characteristics described in the following supplementary notes.

### Supplementary Note 1

A relay device to be used in an in-vehicle system that includes three or more in-vehicle devices, the relay device including:
a processing circuit,
the processing circuit being configured to
   cause the relay device in a sleep state to transition to a wake-up state when receiving a first wake-up request from a first in-vehicle device of the three or more in-vehicle devices; and
select a second in-vehicle device from among the in-vehicle devices other than the first in-vehicle device and transmit a second wake-up request to the second in-vehicle device to cause the second in-vehicle device to transition to the wake-up state.

1. A relay device to be used in an in-vehicle system that includes three or more in-vehicle devices, comprising:
a state transition unit configured to cause the relay device in a sleep state to transition to a wake-up state when receiving a first wake-up request from a first in-vehicle device of the three or more in-vehicle devices; and
a sleep control unit configured to select a second in-vehicle device from among the in-vehicle devices other than the first in-vehicle device and transmit a second wake-up request to the second in-vehicle device to cause the second in-vehicle device to transition to the wake-up state.

2. The relay device according to claim 1, further including:
three or more communication ports to which the three or more in-vehicle devices are to be connected, respectively; and
a storage unit configured to store correspondence information indicating a correspondence between the communication ports and networks to which the in-vehicle devices belong,
wherein the sleep control unit selects the second in-vehicle device based on the correspondence information.

3. The relay device according to claim 2,
wherein the correspondence information indicates a correspondence between the communication ports and VLANs (Virtual Local Area Networks), and
the sleep control unit selects, as the second in-vehicle device, an in-vehicle device belonging to the same VLAN as the VLAN corresponding to the communication port to which the first in-vehicle device is connected, based on the correspondence information.

4. The relay device according to claim 2,
wherein the correspondence information indicates a correspondence between the communication ports and PNCs (Partial Network Clusters), and
the sleep control unit selects, as the second in-vehicle device, an in-vehicle device belonging to the same PNC as the PNC corresponding to the communication port to which the first in-vehicle device is connected, based on the correspondence information.

5. The relay device according to claim 2,
wherein the correspondence information indicates a correspondence between the communication ports, the VLANs, and the PNCs, and
the sleep control unit preferentially selects, as the second in-vehicle device, an in-vehicle device belonging to the same PNC as the PNC corresponding to the communication port to which the first in-vehicle device is connected, over an in-vehicle device belonging to the same VLAN as the VLAN corresponding to the communication port to which the first in-vehicle device is connected.

6. A sleep control method for a relay device to be used in an in-vehicle system that includes three or more in-vehicle devices, comprising the steps of:
causing the relay device in a sleep state to transition to a wake-up state when receiving a first wake-up request from a first in-vehicle device of the three or more in-vehicle devices; and
selecting a second in-vehicle device from among the in-vehicle devices other than the first in-vehicle device and transmitting a second wake-up request to the second in-vehicle device to cause the second in-vehicle device to transition to the wake-up state.

7. A computer program product to be used in a relay device to be used in an in-vehicle system that includes three or more in-vehicle devices, the computer program product comprising a non-transitory, machine-readable medium storing instructions which, when executed by at least one programmable processor, causes at least one programmable processor to perform operations comprising:
causing the relay device in a sleep state to transition to a wake-up state when receiving a first wake-up request from a first in-vehicle device of the three or more in-vehicle devices; and
selecting a second in-vehicle device from among the in-vehicle devices other than the first in-vehicle device and transmit a second wake-up request to the second in-vehicle device to cause the second in-vehicle device to transition to the wake-up state.
